(19) United States
(12) Patent Application Publication
(10) Pub. No.: US 2019/0049139 A1
(43) Pub. Date: Feb. 14, 2019

(54) SYSTEM AND METHOD FOR HOTEL ROOM GUEST DETECTION

(71) Applicant: Ecotel Inc., Los Angeles, CA (US)

(72) Inventor: John Ko, Los Angeles, CA (US)

(21) Appl. No.: 16/009,275

(22) Filed: Jun. 15, 2018

Related U.S. Application Data
(60) Provisional application No. 62/542,856, filed on Aug. 9, 2017.

(51) Int. Cl. F24F 11/63; G05B 15/02; H05B 37/02

(52) U.S. Cl. CPC F24F 11/63; F24F 2120/12; H05B 37/0227; G05B 15/02

(57) ABSTRACT

A hotel guest detection system includes an HVAC system, a thermostat communicatively connected to the HVAC system, at least one processing unit, at least one motion sensor, at least one door sensor, and at least one bed sensor configured to determine whether or not a guest is in a bed. The bed sensor, thermostat, and bed sensor are communicatively connected to the processing unit, and the processing unit is configured to manipulate a setting of the thermostat based on measurements obtained from the bed sensor and the motion sensor. A method of detecting guests in a hotel room is also described.

### CROSS-REFERENCE TO RELATED APPLICATIONS

This application claims priority to U.S. provisional patent application No. 62/542,856, filed on Aug. 9, 2017, incorporated herein by reference in its entirety.

### BACKGROUND OF THE INVENTION

Hotels operate on ever-shrinking profit margins. After employee expenses, the next largest hotel expenditure is on electricity. In recent years, hotels have followed a conservation trend, both to counteract rising energy prices, and to bolster their green credentials to appeal to environmentally-minded customers. Studies have shown that the use of smart devices to control HVAC and lighting systems in hotel guest rooms can reduce total power expenses by up to 35%. The ideal device would be able to detect when one or more guests was present in the room, and when the room is empty, turn off or reduce power to all non-essential systems.

Some hotels implement rudimentary smart HVAC or lighting systems based on motion sensors, but these can suffer from blind spots or register a false negative when one or more guests are asleep and stationary on the bed. Others, notably cruise ships, require guests to leave their room key in a slot in order to register their presence in the room. This system has its own drawbacks, particularly that it increases the likelihood of guests locking themselves out or cheating the system.

Thus, there is a need in the art for a system for efficiently and accurately detecting the presence of guests in a hotel room, in order to better control energy-hungry climate control and lighting systems, save money, and increase guest satisfaction. The present invention satisfies this need.

### SUMMARY OF THE INVENTION

In one aspect, a system for detecting guests in a hotel room includes an HVAC system, a thermostat communicatively connected to the HVAC system, at least one processing unit, at least one door sensor, at least one motion sensor, and at least one bed sensor configured to determine whether or not a guest is in a bed, wherein the door sensor, thermostat, and bed sensor are communicatively connected to the processing unit, and wherein the processing unit is configured to manipulate a setting of the thermostat based on measurements obtained from the door sensor, the bed sensor and the motion sensor.

In one embodiment, the door sensor comprises a motion sensor. In one embodiment, the door sensor comprises a magnet. In one embodiment, the door sensor comprises an ultrasonic sensor. In one embodiment, the processing unit is disposed within the housing of the thermostat. In one embodiment, the system further comprises a smart switch, wherein the smart switch is configured to turn one or more appliances or lights on or off, and wherein the processing unit is configured to signal the smart switch to turn the one or more appliances or lights on or off based on measurements obtained from the door sensor, the bed sensor, and the motion sensor.

In one embodiment, the bed sensor comprises an accelerometer. In one embodiment, the bed sensor comprises a load cell. In one embodiment, the motion sensor comprises a passive infrared sensor. In one embodiment, the system further comprises a remote server communicatively connected to the processing unit, wherein the remote server is configured to collect data from the processing unit and send commands to the processing unit to exercise control over the HVAC system.

In another aspect, a method of the invention comprises the steps of waiting for an event from one of a group of sensors comprising a motion sensor, a door sensor, and a bed sensor, and upon receiving the event, evaluating the received event to determine whether or not a guest is present in a hotel room. If a guest is detected the method further comprises, adjusting at least one temperature limit on a thermostat to a user comfort configuration, and if no guest is detected, the method further comprises adjusting at least one temperature limit on a thermostat according to a stepdown algorithm, then returning to waiting for an event from the group of sensors.

In one embodiment, the door sensor comprises a motion sensor. In one embodiment, the door sensor comprises an ultrasonic sensor. In one embodiment, the method further comprises the steps of checking to see whether instructions were received from a remote server, and if instructions were received from a remote server, adjusting at least one temperature limit on the thermostat according to the instructions.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1 is a system diagram of one embodiment of the invention;

FIG. 2 is a physical diagram of one embodiment of the invention;

FIG. 3 is a network diagram of one embodiment of the invention;

FIG. 4 is a diagram of possible bed sensor placements according to the invention;

FIG. 5 is a physical diagram of a door sensor of one embodiment of the invention;

FIG. 6 is a diagram of possible motion sensor placements according to the invention; and

FIG. 7 is a state diagram of an algorithm of the invention.

### DETAILED DESCRIPTION

It is to be understood that the figures and descriptions of the present invention have been simplified to illustrate elements that are relevant for a clear understanding of the present invention, while eliminating, for the purpose of clarity, many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C#, Objective-C, Java, JavaScript, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G or 4G/LTE networks, Bluetooth®, Bluetooth® Low Energy (BLE), Zigbee®, or Z-Wave® communication links, or any other method by which one electronic device is capable of communicating with another. In some embodiments, elements of the networked portion of the invention may be implemented over a Virtual Private Network (VPN).

In certain embodiments, the system of the present invention comprises some or all of a smart thermostat, control software, and one or more sensors. The one or more sensors may comprise a door sensor, a motion sensor, a bed sensor, or any other sensors known in the art that might be used to detect the presence of one or more persons in an enclosed space. When the system detects the presence of one or more persons in the room, the smart thermostat will behave like a normal thermostat—turning the Heating, Ventilation, and Air Conditioning (HVAC) system on and off to attain some target temperature according to user or remote settings. When the system detects that the room is empty for a certain period of time, the system will turn off or relax the temperature limits on the HVAC system so as to conserve energy. In some embodiments, the system will relax the temperature limits incrementally over time while the room is determined to be empty according to a stepdown algorithm. For example, the system may relax the temperature limits by 3 degrees during the first 20 minutes after a guest's absence has been detected, 7 degrees after 20 minutes have passed but before 40 minutes have passed, and 10 degrees after 40 minutes have passed but before 60 minutes have passed. It is also contemplated that the system may remove temperature limits entirely (effectively turning off the system) when a room is detected as vacant for an extended period of time.

It is understood that the phrase “relaxing the temperature limits” refers to the act of setting a higher threshold temperature for an air cooling/conditioning system when the weather outside is warm, and setting a lower threshold temperature for an air heating system when the weather outside is cold. In one example, the outside temperature is 90 degrees and the thermostat in a hotel room is set to maintain the room's temperature at 70 degrees. When all guests leave the room and the room's vacancy is detected by the one or more sensors of the system, the system may adjust the thermostat threshold to 73 degrees. After 20 minutes, the system may adjust the thermostat threshold to 77 degrees. After another 20 minutes, the system may adjust the thermostat threshold to 80 degrees. In this way, the system is able to conserve energy by preventing the HVAC system from cooling the room needlessly when no guests are present.

The foregoing values for time and temperature steps are understood to be merely presented as examples. The system of the present invention further contemplates temperature steps of a single degree or a fraction of a degree, measured in Fahrenheit or Celsius, or as high as 10 degrees or more. Similarly, the system of the present invention may adjust the temperature threshold by one or more temperature steps at time intervals of five minutes, ten minutes, 30 minutes, one hour, or any other reasonable time interval.

The guest detection system of the present invention comprises one or more of a thermostat, a bed sensor, a motion sensor, and a door sensor. Certain embodiments of the invention may further comprise one or more Light Detection and Ranging (LIDAR), sound, or heat sensors, CO₂ sensors, or any other sensor capable of generating data useful to the determination of the presence of guests in a room. The system of the present invention may further comprise one or more actuators for opening and closing vents, windows, and curtains. In some embodiments, the system of the present invention further comprises one or more electrical relays, smart light bulbs, infrared transmitters, Bluetooth transmitters, or smart outlets, capable of turning lights and appliances (for example televisions) on and off based on a user's detected presence in the room. In some embodiments, the present invention further comprises a central processing unit, configured to aggregate the data from the various sensors and decide whether or not a guest is present in the room. In some embodiments, the central processing unit is integrated into the thermostat, but in other embodiments it may be a separate unit in wired or wireless communication with the various sensors and the thermostat.

A thermostat of one embodiment of the present invention comprises a microprocessor, a quantity of non-transitory digital storage, and memory. Such a thermostat acts as the local data hub for the system of the present invention. The thermostat may further comprise one or more wi-fi adapters, Bluetooth adapters, or cellular data transceivers. The non-transitory digital storage may comprise a set of instructions for executing the computational methods of the present invention, including but not limited to facilitating communication with the various components, collecting data from sensors, and sending control signals to various actuators and relays. In some embodiments, the thermostat is communicatively connected via local networks or the Internet to one or more remote servers, which assist in data collection and processing or which transmit control signals, via the thermostat, to the HVAC, various actuators, and switches. In some embodiments, the remote servers are distinct, discrete computers connected to a network, but in other embodiments the remote servers may be virtual cloud computing instances.

A bed sensor of the present invention comprises a small sensor encased in a housing and physically connected to a bed in the guest room. The bed sensor may be positioned between the mattress and the frame, between the mattress and a box spring, between the mattress and a pillow, between the mattress and another mattress, entirely within the mattress, entirely within the box spring, or entirely within the frame. The bed sensor is configured to detect when the bed is occupied by one or more guests. In some embodiments, the bed sensor comprises an accelerometer. In other embodiments, the bed sensor comprises a piezoelectric element that converts mechanical deformity into electrical signals. In other embodiments, the bed sensor comprises a temperature sensor. In some embodiments, the bed sensor comprises a strain gauge. The bed sensor is generally configured to register when a guest is in the bed and stationary, but will also detect when a guest moves.

A motion sensor of the present invention is any motion sensor known in the art, typically positioned on a wall or the guest room. The motion sensors are configured to detect motion, typically combined with heat, to determine whether a guest is currently in the room and moving. The motion sensor may use passive infrared (PIR) or any other motion sensing method known in the art.

One embodiment of a door sensor of the present invention comprises a motion sensor, a magnetic sensor such as a hall effect sensor or a reed switch, and a magnet. In one embodiment, the door sensor is configured with the motion sensor facing into the room, and the magnet and accompanying sensor configured to detect when the door opens and closes. In order to differentiate between guests entering the room and guests leaving the room, the door sensor first monitors the magnetic sensor to detect when the door is open. When the door is detected as open, the door sensor then waits for an allotted time, then checks the accompanying motion sensor to see whether there is any motion inside the room. If the sensor detects motion in the room, that means that guests have entered the room. If the sensor does not detect motion in the room, that means that guests have left the room and therefore the room is most likely empty. In some embodiments, the door sensor includes an ultrasonic sensor in place of or in addition to the magnet and magnetic sensor. An ultrasonic sensor would measure the position of the door by periodically broadcasting sound waves downward from the wall above the door toward the door. Based on the timing between the broadcast of the sound wave and the echo perceived by a microphone, the ultrasonic sensor could determine whether the door is opened or closed.

The invention further comprises one or more software algorithms to process data received from the various sensors of the invention. The software algorithms may be executed on computing devices located within the guest room, for example on an embedded processor disposed within the thermostat. Some or all of the software algorithms may also be executed on a remote computing device, for example on a server or cloud computing instance connected to the Internet. The software algorithms of the present invention may incorporate machine learning algorithms, big data algorithms, or data modeling algorithms.

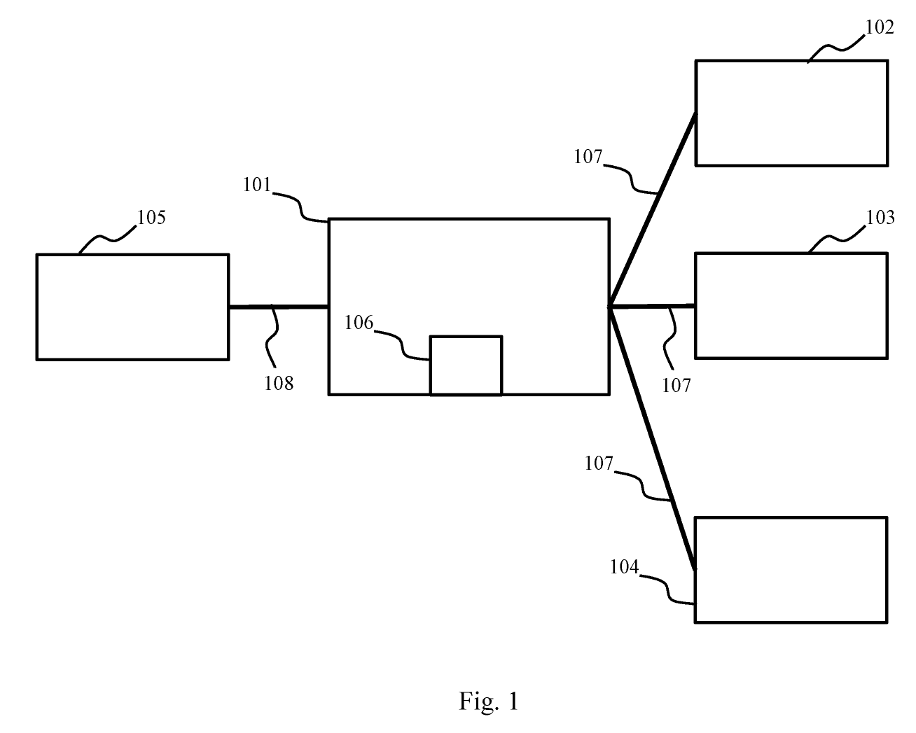

Referring now to FIG. 1, a system diagram of one embodiment of the present invention is shown. Thermostat 101 comprises a microprocessor, non-volatile storage, and memory. In some embodiments, thermostat 101 further comprises internal motion sensor 106. Thermostat 101 is connected via wired or wireless connections 107 and 108 to HVAC system 105, one or more door sensors 102, one or more bed sensors 103, and one or more motion sensors 104. Connection 108 to HVAC system 105 typically uses wires in order to be compatible with existing systems, but a wireless connection 108 to HVAC system 105 is also contemplated.

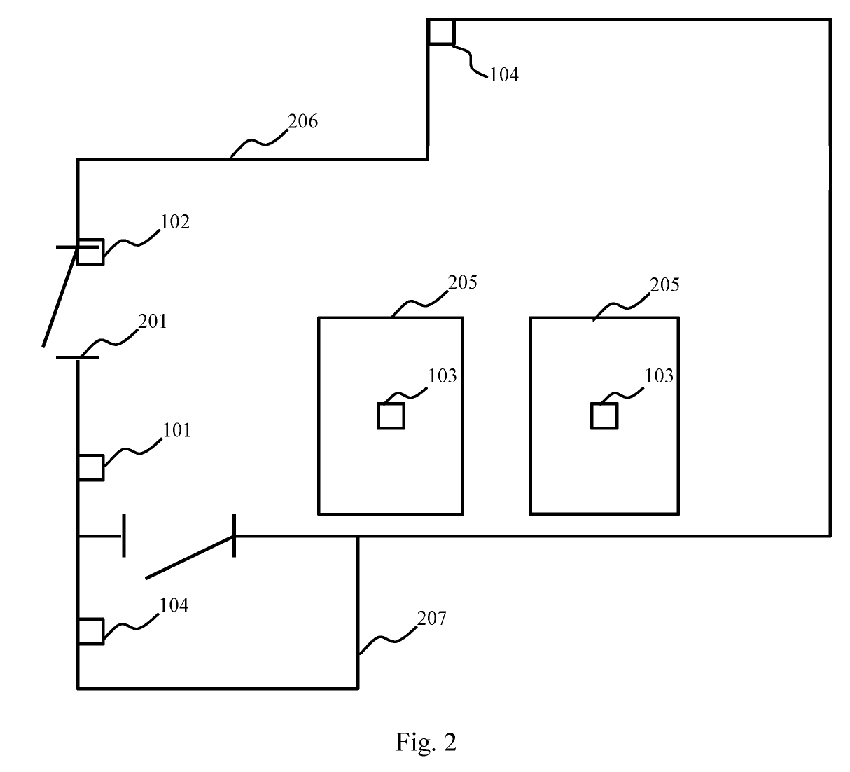

With reference now to FIG. 2, a physical diagram of an exemplary embodiment of the present invention is shown. The placement of the various sensors in FIG. 2 is merely one example of a possible layout, and should not be considered as limiting the scope of the invention. Thermostat 101 is located on one wall of guest room 206. One or more motion sensors 104 are positioned throughout guest room 206, restroom 207, and any other rooms in which it is desirable to monitor guest presence. Some or all of the beds 205 located within the room or rooms are equipped with bed sensors 103, communicatively connected to thermostat 101 or a communication hub. In some embodiments, bed sensors 103 may be positioned between the mattresses of beds 205, under the mattress or mattresses of beds 205, or mounted in the headboards or frames of beds 205. Door sensors 102 are positioned above or otherwise physically adjacent to doors 201, typically on the inside of guest room 206.

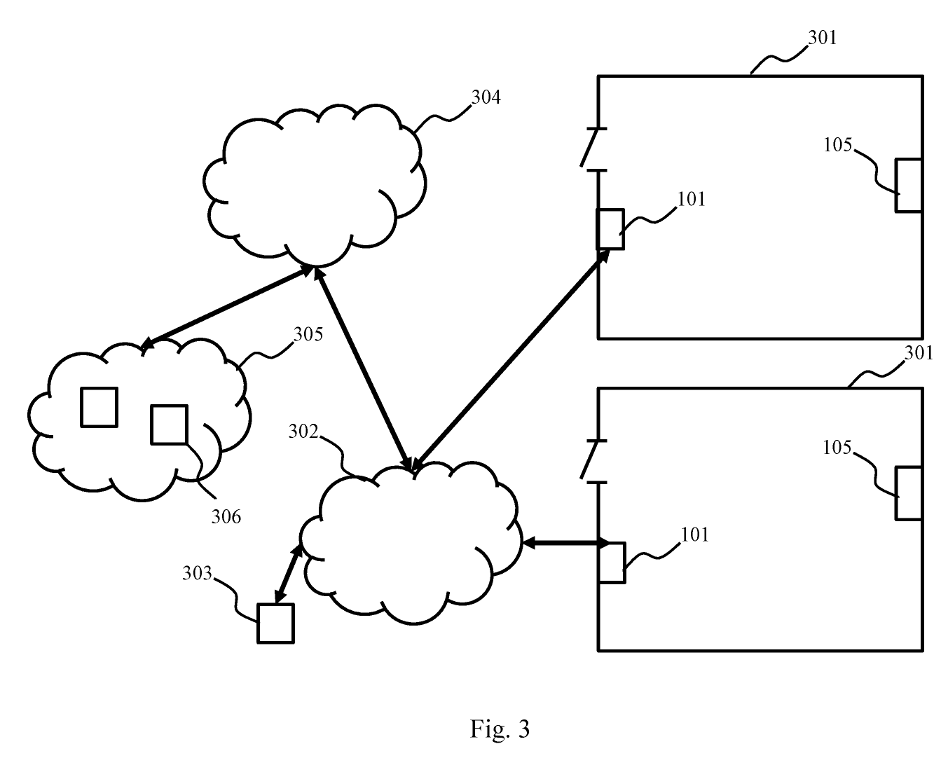

With reference now to FIG. 3, a diagram of the networked structure of the present invention is shown. The diagram depicts an exemplary embodiment of two guest rooms 301 comprising thermostats 101 and HVAC systems 105. Each thermostat 101 is connected to the Internet 304. In some embodiments, thermostats 101 are connected to the Internet via a local network 302. In some embodiments, local network 302 is a wi-fi network, and may be the hotel's main wi-fi network. The system further comprises elastic computing cloud 305, comprising one or more servers or cloud instances 306. Cloud 305 provides management and data storage for the various aspects of the system. In some embodiments, a hotel Property Management System (PMS) 303 is connected to local network 302 and to Internet 304. PMS 303 may be used to collect data from thermostats 101 and the various sensors, as well as to send commands to the system originating from one or more servers 306 or from a computer program stored and running locally on PMS 303. In some embodiments, each thermostat 101 comprises a unique identifier associated with the physical location of that thermostat. In some embodiments, this location is a hotel and hotel room number. In some embodiments, the unique identifier comprises a processor ID.

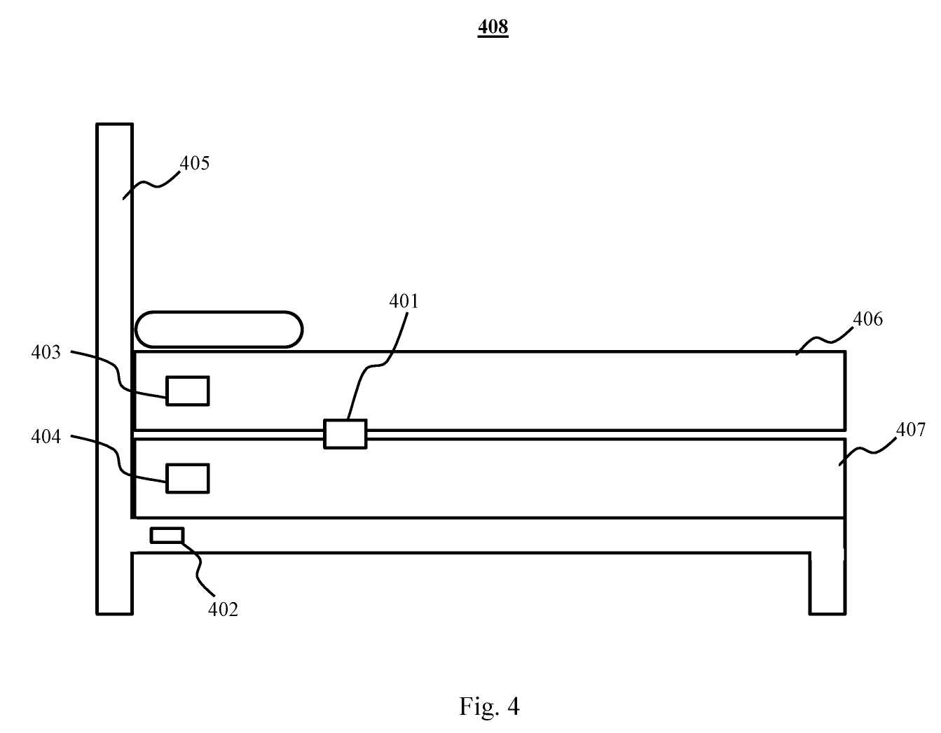

With reference now to FIG. 4, a diagram of possible placements for a bed sensor on a bed 408 is shown. In some embodiments, a bed sensor 401 may be placed between two mattresses or box springs 406 and 407. In some embodiments, a bed sensor 402 may be mounted to a bed frame 405. In some embodiments, a bed sensor 403 may be placed within a top mattress 406, and/or within a bottom mattress or box spring 407. The preceding list of bed sensor placements is not meant to be exclusive, and the bed sensor may optionally be positioned in any other location capable of determining whether or not a bed is occupied.

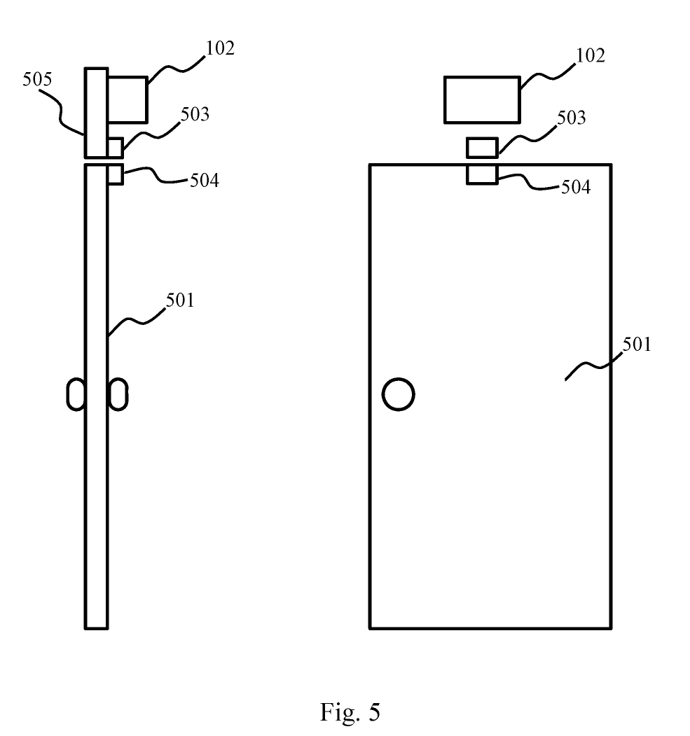

With reference now to FIG. 5, exemplary head-on and profile views of door sensor placement are shown. In the depicted embodiment, the door sensor comprises three parts, door-mounted magnet or magnetic sensor 504, wall-mounted magnet or magnetic sensor 503, and motion sensor 102. The magnetic sensor and the motion sensor are communicatively connected, and the door's state is determined by the magnetic sensor, mounted on either door 501 or wall 505. In some embodiments, the magnetic sensor and motion sensor are electrically connected to one another via one or more wires. If the magnetic sensor detects proximity to the magnet, the door is determined to be closed. If there is no magnet detected in proximity to the magnetic sensor, the door is determined to be open. As detailed above, motion sensor 102 is mounted on the inside of the guest room, and may be mounted on the wall or on door 501. In some embodiments, the magnet and magnetic sensor pair of 503 and 504 may be supplemented or replaced by an ultrasonic sensor.

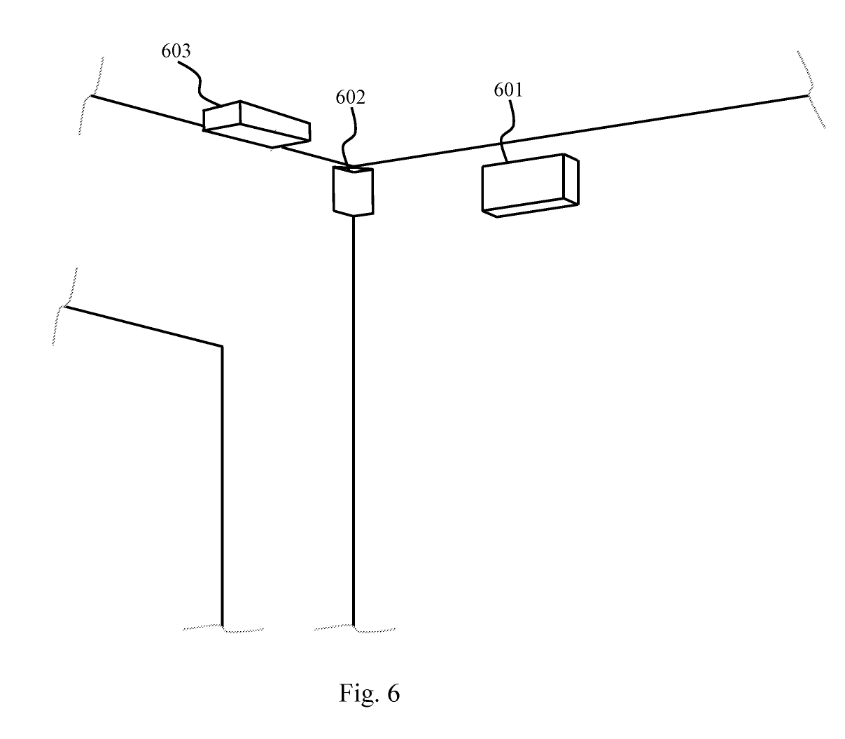

With reference now to FIG. 6, exemplary mounting options for a motion sensor are shown. A motion sensor of the present invention may be mounted on a wall as depicted by 601, in a corner as depicted by 602, or on a ceiling as depicted by 603.

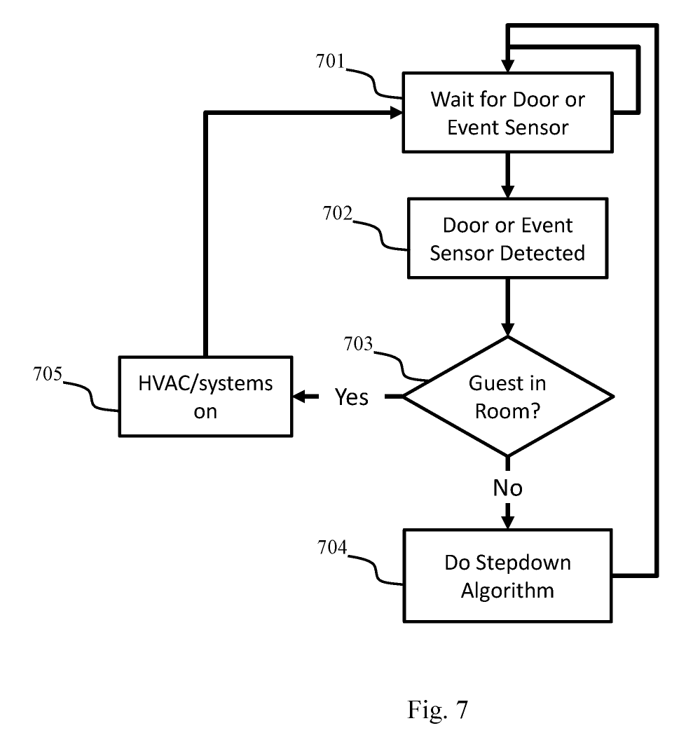

With reference now to FIG. 7, a state diagram of an algorithm of the present invention is shown. The algorithm begins in a loop 701, waiting to receive a door or sensor event. When a door or sensor event 702 is observed, the algorithm determines whether or not the guest is in the room 703. If a guest's presence is detected, the algorithm will turn on HVAC and other power-controlled systems 705 before moving back to wait loop 701. If a guest's presence is not detected, the system will begin the stepdown algorithm 704, then move back to wait loop 701.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A hotel guest detection system comprising:
an HVAC system;
a thermostat communicatively connected to the HVAC system;
at least one processing unit;
at least one door sensor;
at least one motion sensor; and
at least one bed sensor configured to determine whether or not a guest is in a bed;
wherein the door sensor, thermostat, and bed sensor are communicatively connected to the processing unit; and
wherein the processing unit is configured to manipulate a setting of the thermostat based on measurements obtained from the door sensor, the bed sensor, and the motion sensor.

2. The hotel guest detection system of claim 1, wherein the door sensor comprises a motion sensor.

3. The hotel guest detection system of claim 1, wherein the door sensor comprises a magnet.

4. The hotel guest detection system of claim 1, wherein the door sensor comprises an ultrasonic sensor.

5. The hotel guest detection system of claim 1, wherein the processing unit is disposed within the housing of the thermostat.

6. The hotel guest detection system of claim 1, further comprising a smart switch;
wherein the smart switch is configured to turn one or more appliances or lights on or off; and
wherein the processing unit is configured to signal the smart switch to turn the one or more appliances or lights on or off based on measurements obtained from the door sensor, the bed sensor, and the motion sensor.

7. The hotel guest detection system of claim 1, wherein the bed sensor comprises an accelerometer.

8. The hotel guest detection system of claim 1, wherein the bed sensor comprises a load cell.

9. The hotel guest detection system of claim 1, wherein the motion sensor comprises a passive infrared sensor.

10. The hotel guest detection system of claim 1, further comprising a remote server communicatively connected to the processing unit;
wherein the remote server is configured to collect data from the processing unit and send commands to the processing unit to exercise control over the HVAC system.

11. A non-transitory computer-readable medium with instructions stored thereon, that when executed by a processor, performs a hotel guest room management algorithm comprising the steps of:
waiting for an event from one of a group of sensors comprising a motion sensor, a door sensor, and a bed sensor;
upon receiving the event, evaluating the received event to determine whether or not a guest is present in a hotel room;
if a guest is detected, adjust at least one temperature limit on a thermostat to a user comfort configuration;
if no guest is detected, adjust at least one temperature limit on a thermostat according to a stepdown algorithm; and
return to waiting for an event from one of the group of sensors.

12. The non-transitory computer-readable medium of claim 11, wherein the door sensor comprises a motion sensor.

13. The non-transitory computer-readable medium of claim 11, wherein the door sensor comprises an ultrasonic sensor.

14. The non-transitory computer-readable medium of claim 11, further comprising the steps of:
checking to see whether instructions were received from a remote server; and
if instructions were received from a remote server, adjusting at least one temperature limit on the thermostat according to the instructions.
